(19) United States
(12) Patent Application Publication
(10) Pub. No.: US 2024/0428989 A1
(43) Pub. Date: Dec. 26, 2024

(54) REACTOR, CONVERTER AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Naotoshi FURUKAWA, Mie (JP)

(21) Appl. No.: 18/699,290

(22) PCT Filed: Oct. 4, 2022
(86) PCT No.: PCT/JP2022/037180

§ 371 Date: Apr. 7, 2024

(30) Foreign Application Priority Data
Oct. 11, 2021 (JP) 2021-166990

(51) Int. Cl. H01F 37/00; H01F 27/255

(52) U.S. Cl. CPC H01F 37/00; H01F 27/255

(57) ABSTRACT

This reactor is provided with a coil and a magnetic core and is configured such that: a winding section of the coil is disposed on a middle core section of the magnetic core; the middle core section comprises a first middle core section, a second middle core section, and a gap section; the first middle core section comprises a first end section; the second middle core section comprises a second end section; the first end section comprises a recessed section and an annular first surface in which the recessed section opens; the second end section comprises a protruding section that fits into the recessed section and an annular second surface that faces the first surface with a space therebetween; a base surface of the recessed section faces a peak surface of the protruding section with a space therebetween; an inner peripheral surface of the recessed section includes an oblique surface; the oblique surface of the recessed section comprises a contact section that is in contact with the protruding section; and the gap section comprises a first gap section, formed between the base surface and the peak surface, and an annular second gap section, formed between the first surface and the second surface.

### TECHNICAL FIELD

The present disclosure relates to a reactor, a converter and a power conversion device.

This application claims a priority based on Japanese Patent Application No. 2021-166990 filed on Oct. 11, 2021, all the contents of which are hereby incorporated by reference.

### BACKGROUND

Constituent components of a converter to be installed in a vehicle such as a hybrid vehicle include a reactor. Patent Document 1 discloses a reactor provided with a coil including a winding portion and a magnetic core including two core pieces to be engaged with each other. An end part of one core piece is provided with a recess open toward the other core piece. The recess has an annular opening edge. An end part of the other core piece is provided with a protrusion to be fit into the recess. The two core pieces include a contact portion and a gap portion with the recess and the protrusions engaged. The contact portion is an annular part where the recess and the protrusion are in surface contact with each other along the opening edge of the recess. The gap portion is a part formed by a non-contact region of the inner peripheral surface of the recess and the outer peripheral surface of the protrusion.

### PRIOR ART DOCUMENT

### Patent Document

Patent Document 1: JP 2018-182184 A

### SUMMARY OF THE INVENTION

The present disclosure is directed to a reactor with a coil including a winding portion and a magnetic core including a middle core portion, the winding portion being arranged on the middle core portion, the middle core portion including a first middle core portion and a second middle core portion divided in an axial direction of the winding portion and a gap portion provided between the first and second middle core portions, the first middle core portion including a first end part facing the second middle core portion, the second middle core portion including a second end part facing the first middle core portion, the first end part including a recess open toward the second middle core portion and an annular first surface, the recess being open in the first surface, the second end part including a protrusion fit in the recess and an annular second surface facing the first surface while being spaced apart from the first surface in the axial direction, the recess being formed to become smaller with distance from the first surface, a bottom surface of the recess facing a top surface of the protrusion while being spaced apart from the top surface in the axial direction, an inner peripheral surface of the recess including an inclined surface intersecting an axis along the axial direction, the inclined surface of the recess including a contact portion in contact with the protrusion, and the gap portion including a first gap portion formed between the bottom surface and the top surface and an annular second gap portion formed between the first surface and the second surface.

A converter of the present disclosure is provided with the reactor of the present disclosure.

A power conversion device of the present disclosure is provided with the converter of the present disclosure.

### BRIEF DESCRIPTION OF THE DRAWINGS

FIG. 1 is a schematic perspective view showing a reactor according to a first embodiment.

FIG. 2 is a schematic section showing a cross-section along II-II of FIG. 1.

FIG. 3 is a schematic partial section enlargedly showing a first end part of a first middle core portion, a second end part of a second middle core portion and a gap portion in the cross-section shown in FIG. 2.

FIG. 4 is a schematic partial section enlargedly showing only the first end part of the first middle core portion shown in FIG. 3.

FIG. 5 is a schematic partial section enlargedly showing only the second end part of the second middle core portion shown in FIG. 3.

FIG. 6 is a schematic partial section enlargedly showing a first end part of a first middle core portion, a second end part of a second middle core portion and a gap portion in a reactor according to a second embodiment.

FIG. 7 is a schematic section showing a reactor according to a first modification.

FIG. 8 is a schematic section showing a reactor according to a second modification.

FIG. 9 is a configuration diagram schematically showing a power supply system of a hybrid vehicle.

FIG. 10 is a circuit diagram schematically showing an example of a power conversion device provided with a converter.

### DETAILED DESCRIPTION TO EXECUTE THE INVENTION

### Technical Problem

One of characteristics required for a reactor is an inductance. If a magnetic core is magnetically saturated, an inductance is reduced. To suppress the magnetic saturation of the magnetic core, the magnetic core is provided with a gap portion. The inductance varies depending on a magnetic permeability of the entire magnetic core. The magnetic permeability of the magnetic core varies depending on a length and an area of the gap portion, i.e. a volume of the gap portion. To obtain a predetermined inductance, the volume of the gap portion needs to be adjusted.

One object of the present disclosure is to provide a reactor in which a volume of a gap portion is easily adjusted. Another object of the present disclosure is to provide a converter provided with the above reactor. Still another object of the present disclosure is to provide a power conversion device provided with the above converter.

### Effect of Present Disclosure

In the reactor of the present disclosure, a volume of a gap portion is easily adjusted. Further, the converter and the power conversion device of the present disclosure are provided with the reactor having stable inductance characteristics.

### Description of Embodiments of Present Disclosure

First, embodiments of the present disclosure are listed and described.

(1) A reactor according to an embodiment of the present disclosure is provided with a coil including a winding portion and a magnetic core including a middle core portion, the winding portion being arranged on the middle core portion, the middle core portion including a first middle core portion and a second middle core portion divided in an axial direction of the winding portion and a gap portion provided between the first and second middle core portions, the first middle core portion including a first end part facing the second middle core portion, the second middle core portion including a second end part facing the first middle core portion, the first end part including a recess open toward the second middle core portion and an annular first surface, the recess being open in the first surface, the second end part including a protrusion fit in the recess and an annular second surface facing the first surface while being spaced apart from the first surface in the axial direction, the recess being formed to become smaller with distance from the first surface, a bottom surface of the recess facing a top surface of the protrusion while being spaced apart from the top surface in the axial direction, an inner peripheral surface of the recess including an inclined surface intersecting an axis along the axial direction, the inclined surface of the recess including a contact portion in contact with the protrusion, and the gap portion including a first gap portion formed between the bottom surface and the top surface and an annular second gap portion formed between the first surface and the second surface.

In the reactor of the present disclosure, a volume of the gap portion is easily adjusted by the first and second gap portions. By adjusting the volume of the gap portion to a predetermined volume, a predetermined inductance is obtained. Further, since the middle core portion includes the gap portion, the magnetic core is hardly magnetically saturated. Thus, the reactor of the present disclosure has stable inductance characteristics.

In the reactor of the present disclosure, the middle core portion is formed with the first and second gap portions by fitting the recess formed in the first end part of the first middle core portion and the protrusion formed on the second end part of the second middle core portion. By including the contact portion where the inclined surface of the inner peripheral surface of the recess is in contact with the protrusion, the protrusion is positioned with respect to the recess. In this way, a length of the first gap portion and that of the second gap portion are maintained.

The first and second middle core portions are coupled by fitting the recess of the first middle core portion and the protrusion of the second middle core portion. By fitting the recess and the protrusion, the first and second middle core portions are easily assembled and, moreover, can be positioned. Thus, the reactor of the present disclosure is also excellent in the assembly workability of the magnetic core.

(2) In the reactor described in (1) above, each of the first and second middle core portions may be constituted by a compact of a composite material in which a soft magnetic powder is dispersed in a resin.

Since having a relatively small relative magnetic permeability, the compact of the composite material is hardly magnetically saturated. In the configuration of (2) above, the magnetic saturation of the magnetic core is more easily suppressed. Further, if the compacts of the composite materials are used, the recess and the protrusion to be fit to each other can be easily formed with high dimensional accuracy.

(3) In the reactor described in (1) or (2) above, a maximum length of the first gap portion may be 0.3 mm or more and 3 mm or less.

According to the configuration of (3) above, a good inductance is easily ensured while the magnetic saturation is suppressed.

(4) In the reactor described in any one of (1) to (3) above, a maximum length of the second gap portion may be 0.3 mm or more and 3 mm or less.

According to the configuration of (4) above, a good inductance is easily ensured while the magnetic saturation is suppressed.

(5) In the reactor described in any one of (1) to (4) above, an angle of inclination a of the inclined surface of the recess may be 30° or more and 60° or less.

According to the configuration of (5) above, the length of the first gap portion is easily ensured.

(6) In the reactor described in any one of (1) to (5) above, the protrusion may be formed to become smaller with distance from the second surface. An outer peripheral surface of the protrusion may include an inclined surface inclined along the inclined surface of the recess, and the inclined surface of the recess and the inclined surface of the protrusion may be in surface contact at the contact portion.

The positioning accuracy of the protrusion with respect to the recess is improved by bringing the recess and the protrusion into surface contact.

(7) In the reactor described in (6) above, a length of the contact portion may be 0.5 mm or more and 5 mm or less.

The configuration of (7) above can improve the positioning accuracy of the protrusion with respect to the recess.

(8) In the reactor described in any one of (1) to (5) above, an angle of inclination β of an outer peripheral surface of the protrusion may be smaller than an angle of inclination α of the inclined surface of the recess, and the inclined surface of the recess and a peripheral edge part of the top surface of the protrusion may be in line contact at the contact portion.

By bringing the recess and the protrusion into line contact, a non-contact region of the recess and the protrusion increases as compared to the case where the recess and the protrusion are in surface contact. That is, since the volume of the gap portion increases, inductance characteristics are improved.

(9) In the reactor described in any one of (1) to (8) above, each of a Young's modulus of the first middle core portion and that of the second middle core portion may be 20 GPa or more and 50 GPa or less.

In the configuration of (9) above, the shapes of the recess and the protrusion are easily maintained. Thus, the first and second gap portions are easily ensured.

(10) In the reactor described in (9) above, the Young's modulus of the first middle core portion and that of the second middle core portion may be equal.

In the configuration of (10) above, the deformation of the recess and the protrusion is easily suppressed. According to the configuration of (10) above, a predetermined gap portion is easily ensured, wherefore an inductance variation is easily reduced.

(11) In the reactor described in (9) above, the Young's modulus of the first middle core portion and that of the second middle core portion may be different.

In the configuration of (11) above, a fitting state of the recess and the protrusion is easily maintained.

(12) In the reactor described in (11) above, a difference between the Young's modulus of the first middle core portion and that of the second middle core portion may be 5 GPa or more and 30 GPa or less.

In the configuration of (12) above, the fitting state of the recess and the protrusion is more easily maintained.

(13) In the reactor described in any one of (1) to (12) above, the magnetic core may be composed of a first core and a second core, the first core may include the first middle core portion, and the second core may include the second middle core portion.

The configuration of (13) above is excellent in the assembly workability of the magnetic core. The first and second cores are coupled by fitting the recess of the first middle core portion and the protrusion of the second middle core portion. By fitting the recess and the protrusion, the first and second cores of the magnetic core are easily assembled and, moreover, can be positioned.

(14) The converter according to the present disclosure is provided with the reactor of any one of (1) to (13) above.

The converter of the present disclosure is provided with the reactor having stable inductance characteristics.

(15) The power conversion device according to the present disclosure is provided with the converter described in (14) above.

The power conversion device of the present disclosure is provided with the reactor having stable inductance characteristics since including the converter of the present disclosure.

### Details of Embodiments of Present Disclosure

Specific embodiments of the present disclosure are described below with reference to the drawings. The same reference signs in figures denote the same components. Note that the present invention is not limited to these illustrations, but is represented by claims and intended to include all changes in the scope of claims and in the meaning and scope of equivalents.

### First Embodiment

### [Reactor]

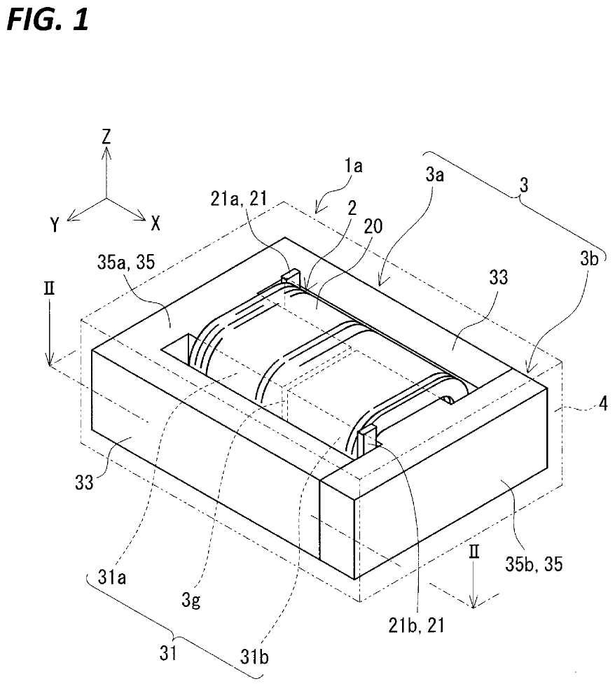

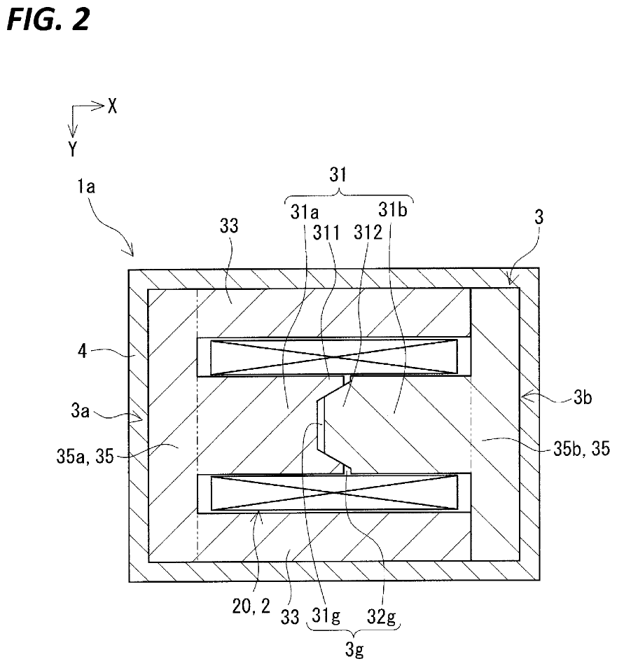

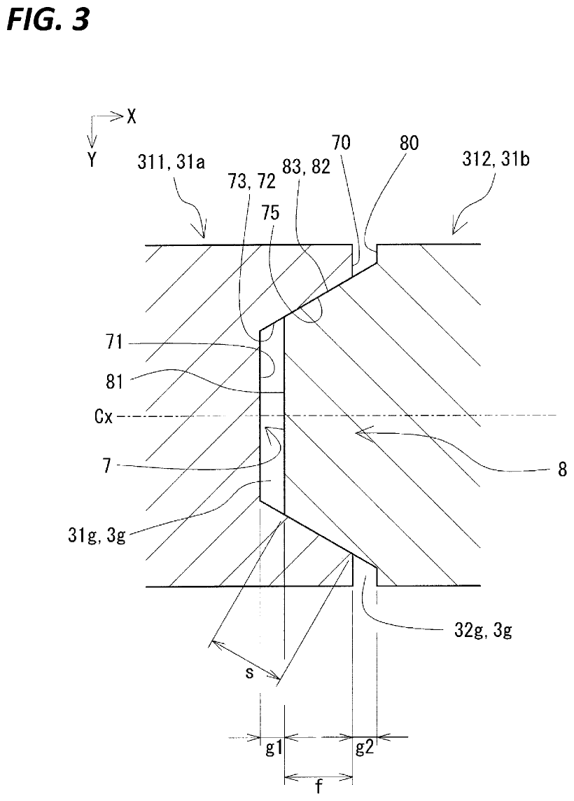

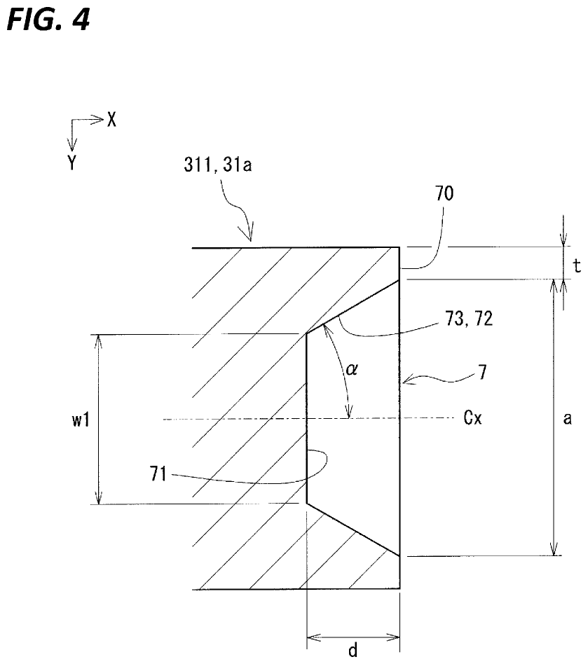

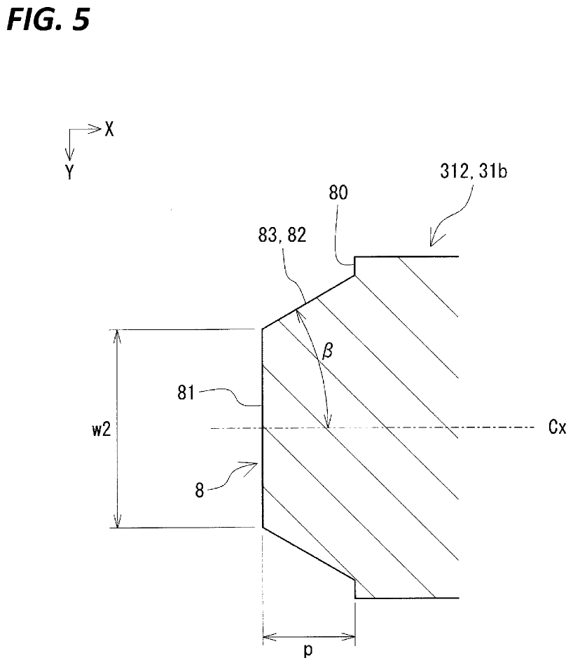

A reactor 1a of a first embodiment is described with reference to FIGS. 1 to 5. As shown in FIGS. 1 and 2, the reactor 1a is provided with a coil 2 and a magnetic core 3. The coil 2 includes a winding portion 22. The magnetic core 3 includes a middle core portion 31. The winding portion 20 is arranged on the middle core portion 31. The middle core portion 31 includes a first middle core portion 31a, a second middle core portion 31b and a gap portion 3g. As shown in FIG. 4, a first end part 311 of the first middle core portion 31a includes a recess 7 and a first surface 70. As shown in FIG. 5, a second end part 312 of the second middle core portion 31b includes a protrusion 8 and a second surface 80. The gap portion 3g is formed with the protrusion 8 fit in the recess 7 as shown in FIG. 3.

One of features of the reactor 1a of the first embodiment is that the gap portion 3g includes a first gap portion 31g and a second gap portion 32g as shown in FIGS. 2 and 3. The configuration of the reactor 1a is described in detail below.

### <Coil>

As shown in FIG. 1, the coil 2 includes a winding portion 20. The winding portion 20 is a part formed by spirally winding a winding wire. A known winding wire can be used as the winding wire. For example, the winding wire is a coated rectangular wire including a conductor wire and an insulation coating covering the conductor wire. The conductor wire is a rectangular wire made of copper. The insulation coating is made of enamel. In this embodiment, one winding portion 20 is provided. A turn number of the winding portion 20 is, for example, 10 turns or more and 60 turns or less, further 20 turns or more and 50 turns or less. In this embodiment, the coil 2 is an edgewise coil formed by winding the coated rectangular wire in an edgewise manner.

The winding portion 20 has a tubular shape. The winding portion 20 may have a polygonal tube shape or a circular tube shape. The polygonal tube shape has a polygonal contour shape of an end surface when viewed from an axial direction of the winding portion 20. The polygonal shapes include, for example, quadrilateral shapes, hexagonal shapes and octagonal shapes. The quadrilateral shapes include rectangular shapes. The rectangular shapes include square shapes. The circular tube shape has a circular contour shape of the end surface. The circular shapes include not only true circular shapes, but also elliptical shapes. In this embodiment, the winding portion 20 has a rectangular tube shape.

The coil 2 includes end portions 21. The end portions 21 are parts of the winding wire pulled out from both end parts of the winding portion 20. The end portions 21 include a first end portion 21a and a second end portion 21b. The first end portion 21a is pulled out to an outer peripheral side of the winding portion 20 from one end part of the winding portion 20. The second end portion 21b is pulled out to the outer peripheral side of the winding portion 20 from the other end part of the winding portion 20. In the first and second end portions 21a, 21b, the insulation coating is stripped to expose the conductor wire. An unillustrated busbar is, for example, connected to the first and second end portions 21a, 21b. The coil 2 is connected to an unillustrated external device by the busbar. The external device is a power supply for supplying power to the coil 2 or the like.

### <Magnetic Core>

As shown in FIGS. 1 and 2, the magnetic core 3 includes the middle core portion 31, side core portions 33 and end core portions 35. The magnetic core 3 is configured into a θ shape as a whole in a plan view. If the coil 2 is energized, a θ-shaped closed magnetic path is formed in the magnetic core 3. In this closed magnetic path, a magnetic flux generated by the coil 2 returns from the middle core portion 31 to the middle core portion 31 through one end core portion 35, the respective side core portions 33 and the other end core portion 35. In this embodiment, the magnetic core 3 includes a first core 3a and a second core 3b. In this embodiment, the magnetic core 3 is configured by combining the first and second cores 3a, 3b. The first and second cores 3a, 3b are combined in the axial direction of the winding portion 20. The first and second cores 3a, 3b are described in detail later.

In the following description, an X direction is a direction along the axial direction of the winding portion 20. A Y direction is a parallel direction of the middle core portion 31 and the side core portions 33. The Y direction is orthogonal to the X direction. AZ direction is a direction orthogonal to both the X and Y directions. In the Z direction, a side where the end portions 21 of the coil 2 are located is referred to as an upper side, and an opposite side thereof is referred to as a lower side. The plan view described above shows a state when the reactor 1a is viewed from above, i.e. from the Z direction. FIG. 2 shows a cross-section of the reactor 1a cut along an X-Y plane orthogonal to the Z-direction at a center position in the Z-direction of the middle core portion 31. In FIG. 2, two-dot chain lines represent boundaries between the middle core portion 31 and the end core portions 35 and boundaries between the side core portions 33 and the end core portions 35.

### Middle Core Portion

The middle core portion 31 includes a part to be arranged inside the winding portion 20. In this embodiment, one middle core portion 31 is provided. The middle core portion 31 is a part to be sandwiched between first and end core portions 35a, 35b, out of the magnetic core 3. The first and second end core portions 35a, 35b are described later. The middle core portion 31 extends along the X-direction. An axial direction of the middle core portion 31 coincides with that of the winding portion 20. In this embodiment, both end parts of the middle core portion 31 project from both end surfaces of the winding portion 20. These projecting parts are also parts of the middle core portion 31.

The shape of the middle core portion 31 is not particularly limited if this shape corresponds to the inner shape of the winding portion 20. In this embodiment, the middle core portion 31 has a substantially rectangular parallelepiped shape. When viewed from the X direction, corner parts of the outer peripheral surface of the middle core portion 31 may be rounded along the inner peripheral surface of the winding portion 20.

The middle core portion 31 is divided in the X direction and includes the first and second middle core portions 31a, 31b. An end surface of the first middle core portion 31a and an end surface of the second middle core portion 31b are facing each other in the X-direction. The first middle core portion 31a is located on one side in the X-direction where the first core 3a is arranged. The one side in the X-direction is a left side in FIG. 2. The second middle core portion 31b is located on the other side in the X-direction where the second core 3b is arranged. The other side in the X-direction is a right side in FIG. 2. A length of each of the first and second middle core portions 31a, 31b may be set as appropriate. The lengths mentioned here mean lengths along the X direction. The length of the first middle core portion 31a is a distance from the boundary between the first middle core portion 31a and the first end core portion 35a to a position most distant from the boundary in the X-direction. In this embodiment, the length of the first middle core portion 31a is a length including the recess 7 and is a distance from the above boundary to the first surface 70 in the X-direction (see also FIG. 3). The length of the second middle core portion 31b is a distance from the boundary between the second middle core portion 31b and the second end core portion 35b to a position most distant from the boundary in the X-direction. In this embodiment, the length of the second middle core portion 31b is a length including the protrusion 8 and is a distance from the above boundary to a top surface 81 in the X-direction (see also FIG. 3). The recess 7 and the first surface 70, and the protrusion 8 and the top surface 81 are described later.

In this embodiment, the end surface of the first middle core portion 31 has a rectangular contour shape. The end surface of the second middle core portion 31b has the same rectangular contour shape as the end surface of the first middle core portion 31a. A maximum value of a dimension in the Y-direction of the first middle core portion 31a is, for example, 15 mm or more and 60 mm or less, further 20 mm or more and 50 mm or less. A maximum value in the Z-direction of the first middle core portion 31a is, for example, 15 mm or more and 60 mm or less, further 20 mm or more and 50 mm or less. In this embodiment, dimensions in the Y and Z directions of the end surface of the first middle core portion 31a include dimensions of the first surface 70. A dimension in the Y-direction of the second middle core portion 31b is equal to that of the first middle core portion 31a. A dimension in the Z-direction of the second middle core portion 31b is equal to that of the first middle core portion 31a. In this embodiment, dimensions in the Y and Z directions of the end surface of the second middle core portion 31b include dimensions of the second surface 80.

The middle core portion 31 includes the gap portion 3g. The gap portion 3g is provided between the first and second middle core portions 31a, 31b. The gap portion 3g is located inside the winding portion 20. By locating the gap portion 3g inside the winding portion 20, a leakage magnetic flux from the gap portion 3g is reduced as compared to the case where the gap portion 3g is located outside the winding portion 20. Thus, a loss due to the leakage magnetic flux from the gap portion 3g can be reduced. The gap portion 3g is described in detail later.

### First End Part of First Middle Core Portion

As shown in FIGS. 3 and 4, the first end part 311 of the first middle core portion 31a includes the recess 7 and the first surface 70. The first end part 311 is facing the second middle core portion 31b as shown in FIG. 3. The recess 7 is open toward the second middle core portion 31b. The first surface 70 is an annular surface in which the recess 7 is open. The first surface 70 is annularly provided to surround an opening of the recess 7. FIGS. 3 and 4 show an X-Y cross-section orthogonal to the Z-direction. Although not shown, an X-Z cross-section orthogonal to the Y-direction is similar to the cross-section shown in FIGS. 3 and 4. In FIGS. 3 and 4, the first surface 70 is present also on upper and lower sides in the Z-direction. The upper side in the Z-direction is a side forward of the plane of FIGS. 3 and 4. The lower side in the Z-direction is a side backward of the plane of FIGS. 3 and 4.

### <Recess>

The recess 7 has a bottom surface 71 and an inner peripheral surface 72. The bottom surface 71 is facing the top surface 81 of the protrusion 8 with the protrusion fit in the recess 7 as shown in FIG. 3. The protrusion 8 is described later. The bottom surface 71 and the top surface 81 are arranged apart in the X-direction. The bottom surface 71 and the top surface 81 are not in contact. The inner peripheral surface 72 connects the first surface 70 and the bottom surface 71. The inner peripheral surface 72 includes an inclined surface 73. An extension of the inclined surface 73 intersects an axis Cx along the X-direction. The inclined surface 73 includes a contact portion 75. The contact portion 75 contacts the protrusion 8. The contact portion 75 is present over the entire periphery of the inner peripheral surface 72 in a circumferential direction. With the protrusion 8 fit in the recess 7, the protrusion 8 is positioned with respect to the recess 7 by the contact portion 75. Since the protrusion 8 is positioned in the X-direction by the contact portion 75, an interval between the bottom surface 71 and the top surface 81 and an interval between the first and second surfaces 70, 80 are maintained. Further, position shifts of the protrusion 8 in the Y and Z directions in the recess 7 can be suppressed.

As shown in FIG. 4, the recess 7 is formed to become smaller with distance from the first surface 70. That is, the recess 7 has a tapered shape to gradually narrow the inner peripheral surface 72 from the opening of the recess 7 toward the bottom surface 71. The shape of the recess 7 is not particularly limited. The shape of the recess 7 means the shape of a space surrounded by the bottom surface 71 and the inner peripheral surface 72. The recess 7 may have, for example, a truncated polygonal pyramid shape or a truncated cone shape. The truncated polygonal pyramid shape is such that a Y-Z cross-sectional shape orthogonal to the X-direction is polygonal and an X-Y cross-sectional shape and an X-Z cross-sectional shape are trapezoidal. The polygonal shapes include, for example, quadrilateral shapes, hexagonal shapes and octagonal shapes. The quadrilateral shapes include rectangular shapes. The rectangular shapes include square shapes. The truncated cone shape is such that a Y-Z cross-sectional shape is circular and an X-Y cross-sectional shape and an X-Z cross-sectional shape are trapezoidal. Circular shapes include not only true circular shapes, but also elliptical shapes.

In this embodiment, the recess 7 has a truncated quadrilateral pyramid shape. The contour shape of the opening of the recess 7 is a rectangular shape similar to the contour shape of the end surface of the first middle core portion 31a. The bottom surface 71 has a rectangular shape. The bottom surface 71 is a flat surface orthogonal to the X-direction. The inner peripheral surface 72 of this embodiment is formed on the inclined surface 73 over an entire length from the first surface 70 to the bottom surface 71. The inclined surface 73 may not be provided over the entire length of the inner peripheral surface 72. The inclined surface 73 only has to be provided in a partial region of the entire length of the inner peripheral surface 72. For example, the inclined surface 73 may be provided only in a partial region on the side of the first surface 70, out of the inner peripheral surface 72.

The bottom surface 71 may be U-shaped or V-shaped instead of being a flat surface in an X-Y or X-Z cross-section. The bottom surface 71 is a part located in a direction separating from the first surface 70 from the contact portion 75 shown in FIG. 3. The position in the X-direction of the bottom surface 71 may include the position of the contact portion 75 and may be the same position as the contact portion 75 or a position distant from the contact portion 75. If the bottom surface 71 is a flat surface as in this embodiment, the bottom surface 71 is at the same position as the contact portion 75 in the X-direction as shown in FIG. 3. For example, if the bottom surface 71 is V-shaped such as when the recess 7 has a polygonal pyramid shape or a cone shape, the bottom surface 71 is a part located on a side more distant from the first surface 70 than the contact portion 75. If the bottom surface 71 is U-shaped, the bottom surface 71 is a part constituted by a curved surface.

Dimensions of the recess 7 and an angle of inclination a of the inclined surface 73 are described later.

### <First Surface>

The first surface 70 is formed into an annular shape when viewed from a side where the recess 7 is open. The first surface 70 is shaped to correspond to the contour shape of the end surface of the first middle core portion 31a. In this embodiment, the first surface 70 has a rectangular annular shape. A width of the first surface 70 is, for example, 0.5 mm or more and 5 mm or less, further 1 mm or more and 2 mm or less. The width of the first surface 70 is a distance from the inner peripheral edge of the opening to the outer peripheral edge of the first surface 70. The first surface 70 of this embodiment is a flat surface orthogonal to the X-direction. The first surface 70 may be an inclined surface inclined with respect to a plane orthogonal to the X-direction.

### Second End Part of Second Middle Core Portion

As shown in FIGS. 3 and 5, the second end part 312 of the second middle core portion 31b includes the protrusion 8 and the second surface 80. The second end part 312 is facing the first middle core portion 31a as shown in FIG. 3. The protrusion 8 projects toward the first middle core portion 31a. The protrusion 8 is fit into the recess 7. The second surface 80 is an annular surface facing the first surface 70. The second surface 80 is annularly provided to surround the protrusion 8. The first and second surfaces 70, 80 are arranged apart in the X-direction. The first and second surfaces 70, 80 are not in contact. FIG. 5 shows an X-Y cross-section orthogonal to the Z-direction. Although not shown, an X-Z cross-section orthogonal to the Y-direction is similar to the cross-section of FIG. 5. In FIGS. 3 and 5, the second surface 80 is present also on upper and lower sides in the Z-direction. The upper side in the Z-direction is a side forward of the plane of FIGS. 3 and 5. The lower side in the Z-direction is a side backward of the plane of FIGS. 3 and 5.

### <Protrusion>

The protrusion 8 has the top surface 81 and an outer peripheral surface 82. The top surface 81 is facing the bottom surface 71 of the recess 7 with the protrusion 8 fit in the recess 7 as shown in FIG. 3. The outer peripheral surface 82 connects the second surface 80 and the top surface 81. In this embodiment, the outer peripheral surface 82 includes an inclined surface 83. An extension of the inclined surface 83 intersects the axis Cx along the X-direction.

The shape of the protrusion 8 is not particularly limited if the protrusion 8 is in contact with the inclined surface 73 with the protrusion 8 fit in the recess 7. In this embodiment, the protrusion 8 is formed to become smaller with distance from the second surface 80 as shown in FIG. 5. That is, the protrusion 8 has a tapered shape to gradually narrow the outer peripheral surface 82 from the second surface 80 toward the top surface 81. The protrusion 8 may have, for example, a truncated polygonal pyramid shape or a truncated cone shape.

In this embodiment, the shape of the protrusion 8 corresponds to the shape of the recess 7. Specifically, the protrusion 8 has a truncated quadrilateral pyramid shape. The top surface 81 has a rectangular shape. The top surface 81 is a flat surface orthogonal to the X-direction. The outer peripheral surface 82 of this embodiment is formed on the inclined surface 83 over an entire length from the second surface 80 to the top surface 81. The inclined surface 83 may not be provided over the entire length of the outer peripheral surface 82. The inclined surface 83 only has to be provided in a partial region of the entire length of the outer peripheral surface 82. For example, the inclined surface 83 may be provided only in a partial region on the side of the top surface 81, out of the outer peripheral surface 82. If the inclined surface 83 is provided only on a part of the outer peripheral surface 82 on the side of the top surface 81, the shape of a region of the protrusion 8 on a side opposite to the top surface 81 has, for example, a polygonal column shape.

The top surface 81 may be U-shaped or V-shaped instead of being a flat surface in an X-Y or X-Z cross-section. The top surface 81 is a part located in a direction separating from the second surface 80 from the contact portion 75 shown in FIG. 3. The position in the X-direction of the top surface 81 may include the position of the contact portion 75 and may be the same position as the contact portion 75 or a position distant from the contact portion 75. If the top surface 81 is a flat surface as in this embodiment, the top surface 81 is at the same position as the contact portion 75 in the X-direction 75 as shown in FIG. 3. For example, if the top surface 81 is V-shaped such as when the protrusion 8 has a polygonal pyramid shape or a cone shape, the top surface 81 is a part located on a side more distant from the second surface 80 than the contact portion 75. If the top surface 81 is U-shaped, the top surface 81 is a part constituted by a curved surface. Dimensions of the protrusion 8 and an angle of inclination B of the inclined surface 83 are described later.

### <Second Surface>

The second surface 80 is formed into an annular shape when viewed from the side of the top surface 81 of the protrusion 8. The second surface 80 is shaped to correspond to the contour shape of the end surface of the second middle core portion 31b. In this embodiment, the second surface 80 has a rectangular annular shape. A width of the second surface 80 is, for example, 0.5 mm or more and 5 mm or less, further 1 mm or more and 2 mm or less. The width of the second surface 80 is a distance from the inner peripheral edge to the outer peripheral edge of the second surface 80. The second surface 80 of this embodiment is a flat surface orthogonal to the X-direction. The second surface 80 may be an inclined surface inclined with respect to a plane orthogonal to the X-direction.

### Gap Portion

The gap portion 3g is formed by fitting the recess 7 and the protrusion 8 as shown in FIG. 3. The gap portion 3g includes the first gap portion 31g and the second gap portion 32g. The first gap portion 31g is formed between the bottom surface 71 and the top surface 81. The second gap portion 32g is formed between the first and second surfaces 70, 80. In FIG. 3, the second gap portion 32g is present also on upper and lower sides in the Z-direction. The second gap portion 32g is annular when viewed from the X-direction.

The size of each of the first and second gap portions 31g, 32g may be set as appropriate to obtain a predetermined inductance. A maximum length g1 of the first gap portion 31g is, for example, 0.3 mm and more and 3 mm or less. The maximum length g1 is a distance along the X-direction between the bottom surface 71 and the top surface 81. Since the maximum length g1 is 0.3 mm or more, the magnetic saturation of the magnetic core 3 is easily suppressed. Since the maximum length g1 is 3 mm or less, it is easily suppressed that a magnetic permeability of the magnetic core 3 is excessively reduced. Thus, a good inductance is easily ensured. Further, if the maximum length g1 is 3 mm or less, a leakage magnetic flux from the first gap portion 31g is easily suppressed. The maximum length g1 may be 1.5 mm or less. If the maximum length g1 is 1.5 mm or less, the leakage magnetic flux is more easily suppressed.

A maximum length g2 of the second gap portion 32g is, for example, 0.3 mm and more and 3 mm or less. The maximum length g2 is a distance along the X-direction between the first and second surfaces 70, 80. Since the maximum length g2 is 0.3 mm or more, the magnetic saturation of the magnetic core 3 is easily suppressed. Since the maximum length g2 is 3 mm or less, it is easily suppressed that the magnetic permeability of the magnetic core 3 is excessively reduced. Thus, a good inductance is easily ensured. Further, if the maximum length g2 is 3 mm or less, a leakage magnetic flux from the second gap portion 32g is easily suppressed. The maximum length g2 may be 1.5 mm or less. If the maximum length g2 is 1.5 mm or less, the leakage magnetic flux is more easily suppressed.

The first and second gap portions 31g, 32g may be air gaps. Nonmagnetic bodies made of resin or ceramic may be arranged in the first and second gap portion 31g, 32g. For example, a region formed by a space and a region made of resin may be present in one gap portion 3g.

The dimensions of the recess 7 and the angle of inclination α of the inclined surface 73, and the dimensions of the protrusion 8 and the angle of inclination β of the inclined surface 83 may be set as appropriate such that each of the first and second gap portions 31g, 32g has a predetermined size.

### <Dimensions of Recess>

With reference to FIG. 4, an example of the dimensions of the recess 7 is described. A width a of the opening of the recess 7 may be set as appropriate according to a dimension of the end surface of the first middle core portion 31a. The width a is a maximum value of the opening dimension. The opening dimension is a dimension in the Y-direction or a dimension in the Z-direction. The width a is, for example, 5 mm or more and 59 mm or less, further 20 mm or more and 30 mm or less. A width w1 of the bottom surface 71 is smaller than the width a of the opening. The width w1 is, for example, 4 mm or more and 58 mm or less, further 19 mm or more and 29 mm or less. The width w1 is a maximum value of the dimension of the bottom surface 71. The dimension of the bottom surface 71 is a dimension in the Y-direction or a dimension in the Z-direction. A depth d of the recess 7 is, for example, 1 mm or more and 10 mm or less, further 2 mm or more and 4 mm or less. The depth d is a distance along the X-direction between the inner peripheral edge of the opening and the bottom surface 71. By setting the width a, the width w1 and the depth d within the above ranges, the first gap portion 31g having a predetermined size is easily obtained. A thickness t of a wall constituting the recess 7 is, for example, 0.5 mm or more and 5 mm or less, further 1 mm or more and 2 mm or less. The thickness t is a distance from the inner peripheral surface 72 to the outer peripheral surface of the first end part 311. By setting the thickness t within the above range, it is easily suppressed that the wall of the recess 7 is chipped or excessively deformed when the protrusion 8 is fit into the recess 7.

### <Angle of Inclination α>

The angle of inclination α of the inclined surface 73 is, for example, 30° or more and 60° or less. The angle of inclination α is the smaller one of angles formed by the axis Cx and the extension of the inclined surface 73. By setting the angle of inclination α within the above range, the first gap portion 31g having a predetermined size is easily obtained. Further, the angle of inclination α may be 40° or more and 50° or less.

### <Dimensions of Protrusion>

With reference to FIG. 5, an example of the dimensions of the protrusion 8 is described. The dimensions of the protrusion 8 may be set as appropriate according to the dimensions of the recess 7 so that the first and second gap portions 31g, 32g are formed with the protrusion 8 fit in the recess 7 as shown in FIG. 3. A width w2 of the top surface 81 is smaller than the width a of the opening and larger than the width w1 of the bottom surface 71. The width w2 is, for example, 4.5 mm or more and 58.5 mm or less, further 19.5 mm or more and 29.5 mm or less. The width w2 is a maximum value of the dimension of the top surface 81. The dimension of the top surface 81 is a dimension in the Y-direction or a dimension in the Z-direction. A height p of the protrusion 8 is, for example, 1 mm or more and 10 mm or less, further 2 mm or more and 4 mm or less. The height p is a distance along the X-direction between the second surface 80 and the top surface 81. By setting the width w2 and the height p within the above ranges, the first gap portion 31g having the predetermined size is easily obtained.

### <Angle of Inclination β>

The angle of inclination β of the inclined surface 83 is, for example, 30° or more and 60° or less. The angle of inclination B is the smaller one of angles formed by the axis Cx and the extension of the inclined surface 83. By setting the angle of inclination β within the above range, the first gap portion 31g having the predetermined size is easily obtained. Further, the angle of inclination β may be 40° or more and 50° or less. In this embodiment, the angle of inclination β of the inclined surface 83 is equal to the angle of inclination α of the inclined surface 73 are equal. Thus, the inclined surfaces 73, 83 are in surface contact at the contact portion 75. By the surface contact of the inclined surfaces 73, 83, the positioning accuracy of the protrusion 8 with respect to the recess 7 is improved.

A fitting state of the recess 7 and the protrusion 8 is described with reference to FIG. 3. If the inclined surfaces 73, 83 are in surface contact, a length s of the contact portion 75 along the inclined surface 73 is, for example, 0.5 mm or more and 5 mm or less. The length s is called a contact length s below. The contact length s is a length of a contact part of the inclined surfaces 73, 83 along an inclination direction of the inclined surfaces 73, 83. By ensuring the certain contact length s, the positioning accuracy of the protrusion 8 with respect to the recess 7 can be improved. Further, the contact length s may be 0.5 mm or more and 3 mm or less, or 0.6 mm or more and 1 mm or less. The contact portion 75 of this embodiment is present over the entire peripheries of the inner peripheral surface 72 of the recess 7 and the outer peripheral surface 82 of the protrusion 8.

Besides, a length f of the protrusion 8 fit in the recess 7 may be set as appropriate to form the first and second gap portions 31g, 32g. The length f is called a fitting length f below. The fitting length f is a distance along the X-direction from the first surface 70 to the top surface 81. The fitting length f is smaller than the depth d of the recess 7 and smaller than the height p of the protrusion 8. The fitting length f is, for example, 0.5 mm or more and 5 mm or less. Further, the fitting length f may be 0.5 mm or more and 3 mm or less, or 0.6 mm or more and 1 mm or less.

### End Core Portions

As shown in FIGS. 1 and 2, the end core portions 35 are parts to be arranged outside the winding portion 20. Two end core portions 35 are provided. The two end core portions 35 are arranged apart in the X direction. The end core portions 35 include the first end core portion 35a and the second end core portion 35b. The first end core portion 35a is located on the one side in the X-direction. The first end core portion 35a is facing one end surface of the winding portion 20. An end part of the middle core portion 31 on the one side in the X-direction, specifically, an end part of the first middle core portion 31a, is connected to the first end core portion 35a. The second end core portion 35b is located on the other side in the X-direction. The second end core portion 35b is facing the other end surface of the winding portion 20. An end part of the middle core portion 31 on the other side in the X-direction, specifically, an end part of the second middle core portion 31b, is connected to the second end core portion 35b.

The shape of each of the first and second end core portions 35a, 35b is not particularly limited if the first and second end core portions 35a, 35b are shaped to form a predetermined magnetic path. In this embodiment, each of the first and second end core portions 35a, 35b has a substantially rectangular parallelepiped shape.

### Side Core Portions

As shown in FIGS. 1 and 2, the side core portions 33 are parts to be arranged outside the winding portion 20. Two side core portions 33 are provided. The two side core portions 33 are arranged apart in the Y-direction. The two side core portions 33 are arranged in parallel across the middle core portion 31. That is, the middle core portion 31 is arranged between the two side core portions 33. One side core portion 33 is located on one side in the Y-direction. The one side core portion 33 is facing a side surface on the one side in the Y-direction, out of the outer peripheral surface of the winding portion 20. The one side in the Y-direction is an upper side in FIG. 2. The other core portion 33 is located on the other side in the Y-direction. The other side core portion 33 is facing a side surface on the other side in the Y-direction, out of the outer peripheral surface of the winding portion 20. The other side in the Y-direction is a lower side in FIG. 2.

Each side core portion 33 extends in the X-direction. An axial direction of each side core portion 33 is parallel to that of the middle core portion 31. An end part of the side core portion 33 on the one side in the X-direction is connected to the first end core portion 35a. An end part of the side core portion 33 on the other side in the X-direction is connected to the second end core portion 35b. Cross-sectional areas of the respective side core portions 33 may be equal or different. In this embodiment, the cross-sectional areas of the two side core portions 33 are equal. Further, in this embodiment, a total cross-sectional area of the two side core portions 33 is equal to a cross-sectional area of the middle core portion 31. The total cross-sectional area of the two side core portions 33 may be different from the cross-sectional area of the middle core portion 31. The cross-sectional area mentioned here means an area of a cross-section orthogonal to the X direction.

Each side core portion 33 may have a length to link the first and second end core portions 35a, 35b. The shape of the side core portion 33 is not particularly limited. In this embodiment, each side core portion 33 has a substantially rectangular parallelepiped shape.

### First Core, Second Core

The first core 3a includes the first middle core portion 31a. The second core 3b includes the second middle core portion 31b. The shapes of the first and second cores 3a, 3b can be selected from various combinations. In this embodiment, the magnetic core 3 is of an E-T type by combining the E-shaped first core 3a and the T-shaped second core 3b as shown in FIGS. 1 and 2.

### <First Core>

In this embodiment, the first core 3a includes the first middle core portion 31a, the first end core portion 35a and the two side core portions 33. The first middle core portion 31a, the first end core portion 35a and the two side core portions 33 are integrally formed. Since the first core 3a is an integrally formed body, each core portion constituting the first core 3a is made of the same material. That is, each core portion constituting the first core 3a has substantially the same magnetic properties and mechanical properties. The first middle core portion 31a extends in the X direction from an intermediate part in the Y direction of the first end core portion 35a toward the second middle core portion 31b. The respective side core portions 33 extend from both end parts in the Y direction of the first end core portion 35a toward the second end core portion 35b. The first core 3a is E-shaped when viewed from the Z direction.

### <Second Core>

In this embodiment, the second core 3b includes the second middle core portion 31b and the second end core portion 35b. The second middle core portion 31b and the second end core portion 35b are integrally formed. Since the second core 3b is an integrally formed body, each core portion constituting the second core 3b is made of the same material. That is, each core portion constituting the second core 3b has substantially the same magnetic properties and mechanical properties. The second middle core portion 31b extends in the X direction from an intermediate part in the Y direction of the second end core portion 35b toward the first middle core portion 31a. The second core 3b is T-shaped when viewed from the Z direction.

The first and second cores 3a, 3b are coupled by fitting the recess 7 formed in the first end part 311 of the first middle core portion 31a and the protrusion 8 formed on the second end part 312 of the second middle core portion 31b.

In this embodiment, the magnetic core 3 is composed of two pieces including the first and second cores 3a, 3b. That is, the division number of the magnetic core 3 is two. The division number of the magnetic core 3 and positions where the magnetic core 3 is divided are not particularly limited. The magnetic core 3 may be composed of three or more pieces. For example, the first end core portion 35a, the second end core portion 35b, the first middle core portion 31a, the second middle core portion 31b and the two side core portions 33 may be respectively individually configured, and the magnetic core 3 may be configured by combining these. If the magnetic core 3 is composed of the first and second cores 3a, 3b as in this embodiment, the magnetic core 3 is easily assembled since there are only two core pieces to be combined.

### Materials of Cores

The first and second cores 3a, 3b are constituted by compacts of soft magnetic materials. The compacts are, for example, powder compacts or compacts of composite materials.

The powder compact is formed by compression-forming a raw material powder containing a soft magnetic powder. The powder compact has a higher content of the soft magnetic powder than the compact of the composite material. Thus, the powder compact has higher magnetic properties than the compact of the composite material. The magnetic properties include, for example, a relative magnetic permeability and a saturated magnetic flux density. The powder compact may contain, for example, at least one of a binder resin and a molding aid. A content of the soft magnetic powder in the powder compact is, for example, 85% by volume or more and 99.99% by volume or less when the powder compact is 100% by volume.

In the compact of the composite material, the soft magnetic powder is dispersed in a resin. The compact of the composite material is obtained by filling a fluid raw material, in which the soft magnetic powder is dispersed in the uncured resin, into a mold and solidifying the resin. Injection molding or cast molding can be utilized as a composite material molding method. The compact of the composite material can easily adjust a content of the soft magnetic powder. Thus, the compact of the composite material easily adjusts the magnetic properties. A content of the soft magnetic powder in the compact of the composite material is, for example, 20% by volume or more and 85% by volume or less, further 30% by volume or more and 80% by volume or less, when the compact of the composite material is 100% by volume. A content of the resin in the compact of the composite material is, for example, 20% by volume or more and 80% by volume or less, further 20% by volume or more and 70% by volume or less. A content of the soft magnetic powder in the compact of the composite material is less than that of the soft magnetic powder in the powder compact. Thus, a relative magnetic permeability of the compact of the composite material is smaller than that of the powder compact.

Particles constituting the soft magnetic powder are at least one type of particles of soft magnetic metal, coated particles including insulation coatings on the outer peripheries of particles of soft magnetic metal and particles of soft magnetic nonmetal. The soft magnetic metal is, for example, pure iron or an iron-based alloy. The iron-based alloy is, for example, a Fe (iron)-Si (silicon) alloy, a Fe—Ni (nickel) alloy or a Fe—Si—Al (aluminum) alloy. The insulation coating is, for example, a phosphate. The soft magnetic nonmetal is, for example, ferrite.

The resin of the compact of the composite material may be a thermosetting resin or a thermoplastic resin. The thermosetting resin is, for example, an unsaturated polyester resin, an epoxy resin, a urethane resin or a silicone resin. The thermoplastic resin is, for example, a polyphenylene sulfide resin, a polytetrafluoroethylene resin, a liquid crystal polymer, a polyamide resin, a polybutylene terephthalate resin or an acrylonitrile-butadiene-styrene resin. The polyamide resin is, for example, nylon 6, nylon 66 or nylon 9T. Besides, the resin of the compact of the composite material may be, for example, a BMC (Bulk Molding Compound), a millable-type silicone rubber or a millable-type urethane rubber. The BMC is, for example, a mixture of an unsaturated polyester and calcium carbonate or glass fibers. The resin of the compact of the composite material may be a resin excellent in heat resistance. Specific examples of the resin excellent in heat resistance include polyphenylene sulfide resins and polyamide resins including nylons.

The compact of the composite material may contain a filler in addition to the soft magnetic powder and the resin. The filler is, for example, a ceramic filler made of alumina or silica. By containing the filler, the compact of the composite material can enhance heat dissipation. A content of the filler is, for example, 0.2% by mass or more and 20% by mass or less, further 0.3% by mass or more and 15% by mass or less, or 0.5% by mass or more and 10% by mass or less when the compact of the composite material is 100% by volume.

A content of the soft magnetic powder in the powder compact or the compact of the composite material is assumed to be equivalent to an area ratio of the soft magnetic powder in a cross-section of the compact. The content of the soft magnetic powder is obtained as follows. A cross-section of the compact is observed by a scanning electron microscope (SEM) and observation images are obtained. A magnification of the SEM is set to 200× or more and 500× or less. The number of the obtained observation images is 10 or more. A total area of the observation image is set to 0.1 cm² or more. One observation image may be obtained for one cross-section or a plurality of observation images may be obtained for one cross-section. An image processing is applied to each obtained observation image to extract the contours of the particles of the soft magnetic powder. The image processing is, for example, a binarization processing. A total area of the particles of the soft magnetic powder in each observation image is calculated, and an area ratio of the particles of the soft magnetic powder in each observation image is obtained. An average value of the area ratios in all the observation images is regarded as the content of the soft magnetic powder.

In this embodiment, each of the first and second cores 3a, 3b is the compact of the composite material. A relative magnetic permeability of the compact of the composite material is relatively small. Thus, the magnetic core 3 is hardly magnetically saturated by constituting the first and second cores 3a, 3b by the compacts of the composite material. Further, if the compacts of the composite materials are used, the recess 7 and the protrusion 8 to be fit to each other are easily formed with high dimensional accuracy.

### Young's Moduli of Cores

Each of a Young's modulus of the first core 3a and that of the second core 3b is, for example, 20 GPa or more and 50 GPa or less. That is, each of a Young's modulus of the first middle core portion 31a and that of the second middle core portion 31b is 20 GPa or more and 50 GPa or less. By setting the Young's modulus of the first middle core portion 31a and that of the second middle core portion 31b within the above range, excessive deformation of the recess 7 and the protrusion 8 hardly occurs with the recess 7 and the protrusion 8 fit. Since the shapes of the recess 7 and the protrusion 8 are easily maintained, the first and second gap portions 31g, 32g are easily ensured.

The Young's modulus of the first core 3a and that of the second core 3b may be equal or different. In this embodiment, the first and second cores 3a, 3b are made of the same material. The same material means that the types and contents of the soft magnetic powder and the resin constituting the compact of the composite material are the same. The type of the soft magnetic powder is a concept also including the sizes and shapes of the particles constituting the soft magnetic powder. The sizes of the particles of the soft magnetic powder are, for example, particle diameters of the particles. The particles of the soft magnetic powder have, for example, a spherical shape or a flake shape. If the compact of the composite material contains a filler, the same material means that the type, size and content of the filler are also the same. Since the first and second cores 3a, 3b are made of the same material in this embodiment, the Young's modulus of the first core 3a and that of the second core 3b are equal. Since the Young's modulus of the first core 3a and that of the second core 3b are equal, the deformation of at least one of the recess 7 and the protrusion 8 is easily suppressed when the protrusion 8 is fit into the recess 7. Thus, the predetermined gap portion 3g including the first gap portion 31g and the second gap portion 32g is easily ensured, wherefore an inductance variation is easily reduced.

### Miscellaneous

The reactor 1a is provided with a resin molded member 4 as another component as shown in FIGS. 1 and 2. The resin molded member 4 is shown by two-dot chain lines in FIG. 1.

### Resin Molded Member

The resin molded member 4 covers at least a part of the outer peripheral surface of the magnetic core 3. The resin molded member 4 integrates the combined first and second cores 3a, 3b. Further, the resin molded member 4 integrates the coil 2 and the magnetic core 3. In this embodiment, the resin molded member 4 is filled between the inner peripheral surface of the winding portion 20 and the middle core portion 31. Thus, the coil 2 is held positioned with respect to the magnetic core 3 by the resin molded member 4. Further, electrical insulation between the coil 2 and the magnetic core 3 is ensured by the resin molded member 4. A resin similar to the resin of the aforementioned compact of the composite material can be, for example, used as a resin for constituting the resin molded member 4. The resin molded member 4 may cover the outer peripheral surface of the winding portion 20. The resin molded member 4 may be formed to expose at least one of the upper and lower surfaces of the winding portion 20.

In this embodiment, the resin of the resin molded member 4 is filled into the second gap portion 32g through between the inner peripheral surface of the winding portion 20 and the middle core portion 31. The resin of the relative magnetic permeability 4 is not filled into the first gap portion 31g due to the contact portion 75 of the recess 7 and the protrusion 8. Thus, the first gap portion 31g is an air gap.

### Holding Members

The reactor 1a may be provided with unillustrated holding members. The holding members are respectively arranged between the one end surface of the winding portion 20 and the first end core portion 35a and between the other end surface of the winding portion 20 and the second end core portion 35b. The holding members determine relative positions of the coil 2 and the magnetic core 3. Further, electrical insulation between the coil 2 and the magnetic core 3 is ensured by the holding members. The holding members can be made of resin similar to the resin of the aforementioned compact of the composite material.

### Functions and Effects of First Embodiment

In the reactor 1a of the first embodiment, a volume of the gap portion 3g is easily adjusted by the first and second gap portions 31g, 32g. By adjusting the volume of the gap portion 3g to a predetermined volume, a predetermined inductance is obtained. Further, since the middle core portion 31 includes the gap portion 3g, the magnetic core 3 is hardly magnetically saturated. Thus, the reactor 1a has stable inductance characteristics.

By fitting the recess 7 of the first middle core portion 31a and the protrusion 8 of the second middle core portion 31b, the first and second gap portions 31g, 32g are formed in the middle core portion 31. With the recess 7 and the protrusion 8 fit, the protrusion 8 is positioned with respect to the recess 7 since the inclined surface 73 of the recess 7 has the contact portion 75 in contact with the protrusion 8. Since the interval between the bottom surface 71 and the top surface 81 and the interval between the first and second surfaces 70, 80 are maintained, the length g1 of the first gap portion 31g and the length g2 of the second gap portion 32g are maintained. Further, since position shifts of the protrusion 8 in the Y and X directions in the recess 7 are suppressed by the contact portion 75, the first and second middle core portions 31a, 31b are positioned. Further, since the recess 7 and the protrusion 8 are in surface contact at the contact portion 75 in the first embodiment, the positioning accuracy of the protrusion 8 with respect to the recess 7 is improved.

The first and second cores 3a, 3b are coupled by fitting the recess 7 of the first middle core portion 31a and the protrusion 8 of the second middle core portion 31b. The first and second cores 3a, 3b of the magnetic core 3 are easily assembled and, moreover, can be positioned by fitting the recess 7 and the protrusion 8. Thus, the magnetic core 3 is also excellent in assembly workability.

### Second Embodiment

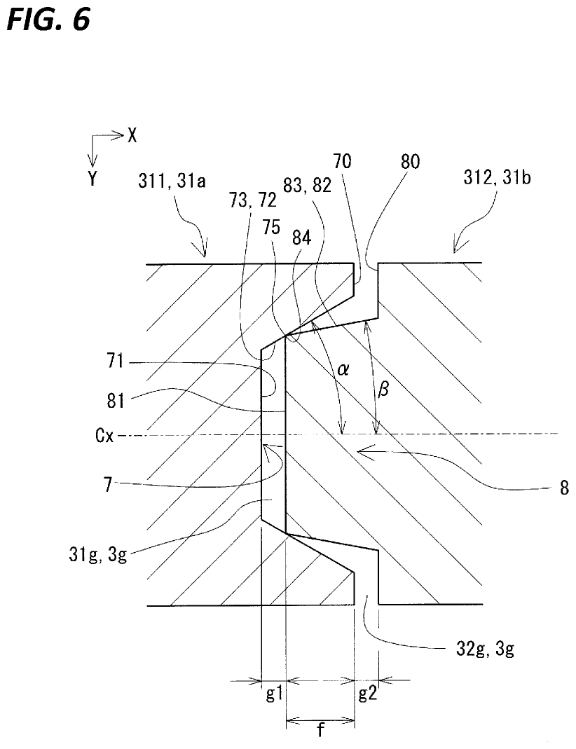

A reactor of a second embodiment is described with reference to FIG. 6. The reactor of the second embodiment differs from the reactor 1a of the first embodiment in that a recess 7 and a protrusion 8 are in line contact at a contact portion 75. The following description is centered on points of difference from the first embodiment. Components similar to those of the first embodiment are denoted by the same reference signs and not described.

In the second embodiment, an angle of inclination β of an outer peripheral surface 82 of the protrusion 8 is smaller than an angle of inclination α of an inclined surface 73 of the recess 7. At the contact portion 75, the inclined surface 73 and a peripheral edge part 84 of a top surface 81 are in line contact. The peripheral edge part 84 includes a ridge formed by the top surface 81 and the outer peripheral surface 82. In this embodiment, the ridge is in contact with the inclined surface 73. In this embodiment, the outer peripheral surface 82 is formed on the inclined surface 83. The protrusion 8 is formed to become smaller with distance from a second surface 80 as shown in FIG. 6. Such a shape is referred to as a tapered shape below. Although not shown, the protrusion 8 may be formed to become larger with distance from the second surface 80. Such a shape is referred to as a widened shape. The outer peripheral surface 82 may or may not include the inclined surface 83. If the outer peripheral surface 82 does not include the inclined surface 83, the outer peripheral surface 82 is parallel to an axis Cx. That is, the angle of inclination β is zero. In the case of the tapered shape, the angle of inclination β is not particularly limited if being smaller than the angle of inclination α. The angle of inclination β is 0° or more and less than the angle of inclination α. The angle of inclination ⊕ may be smaller than the angle of inclination α by 3° or more and 5° or less. In the case of the widened shape, the angle of inclination β is, for example, more than 0° and 45° or less, further 25° or less.

### Functions and Effects of Second Embodiment

A volume of a gap portion 3g is easily adjusted by first and second gap portions 31g, 32g in the reactor of the second embodiment, similarly to the reactor 1a of the first embodiment.

According to the reactor of the second embodiment, a non-contact region of the recess 7 and the protrusion 8 increases as compared to the case where the recess 7 and the protrusion 8 are in surface contact as shown in FIG. 3 since the recess 7 and the protrusion 8 are in line contact at the contact portion 75. Since the volume of the gap portion 3g increases, an improvement in inductance characteristics can be expected. The line contact mentioned here means not only a case where the inclined surface 73 and the peripheral edge part 84 are geometrically in line contact, but also a range in which these are regarded to be substantially in line contact. The inclined surface 73 and the peripheral edge part 84 are regarded to be in line contact if the contact length s shown in FIG. 3 is less than 0.5 mm, further 0.4 mm or less. If the protrusion 8 has the widened shape, the volume of the gap portion 3g can be increased as compared to the tapered shape.

### Third Embodiment

A reactor of a third embodiment differs from the reactor 1a of the first embodiment in a Young's module of a first core 3a and that of a second core 3b are different. That is, a Young's module of a first middle core portion 31a and that of a second middle core portion 31b are different. Since the other configuration is the same as the reactor 1a of the first embodiment shown in FIGS. 1 to 5 except different Young's moduli, it is not shown.

A magnitude relationship of the Young's module of the first core 3a and that of the second core 3b is not particularly limited. The Young's module of the first core 3a may be larger than that of the second core 3b or may be smaller than that of the second core 3b. The core having a high Young's module is difficult to deform, and the core having a low Young's module is easily deformed. A difference between the Young's module of the first core 3a and that of the second core 3b, i.e. a difference between the Young's module of the first middle core portion 31a and that of the second middle core portion 31b, is, for example, 5 GPa or more and 30 GPa or less, further 5 GPa or more and 20 GPa or less.

Methods for adjusting a Young's module of a compact of a composite material constituting the core are described. In a first method, the Young's module of the compact of the composite material is adjusted by changing a particle diameter or a content of a soft magnetic powder constituting the compact of the composite material. The larger a contact area of the soft magnetic powder and a resin, the higher the Young's module of the compact of the composite material. Thus, the Young's module of the compact of the composite material increases by reducing the particle diameter of the soft magnetic powder or increasing the content of the soft magnetic powder.

An average particle diameter of the soft magnetic powder in the core having a high Young's module is made smaller than that of the soft magnetic powder in the core having a low Young's module. The average particle diameter of the soft magnetic powder in the core having a high Young's module and that of the soft magnetic powder in the core having a low Young's module may be set as appropriate so that the Young's module of each core has a predetermined value. The average particle diameter of the soft magnetic powder in the core having a high Young's module is, for example, 20 μm or more and 100 μm or less, further 50 μm or more and 70 μm or less. The average particle diameter of the soft magnetic powder in the core having a low Young's module is, for example, 80 μm or more and 200 μm or less, further 100 μm or more and 150 μm or less.

The average particle diameter of the soft magnetic powder in the compact of the composite material is obtained as follows. A cross-section of the compact is observed by the SEM and observation images are obtained. A magnification of the SEM is set to 200× or more and 500× or less. The number of the obtained observation images is 10 or more. One observation image may be obtained for one cross-section or a plurality of observation images may be obtained for one cross-section. An image processing is applied to each obtained observation image to extract the contours of the particles of the soft magnetic powder. The image processing is, for example, a binarization processing. Particle diameters of all the particles of the soft magnetic powder are measured in each observation image. A diameter of a circle having an area equal to that of each particle is regarded as the particle diameter of each particle. An average value of the particle diameters of the particles in all the observation images is regarded as the average particle diameter of the soft magnetic powder.

A content of the soft magnetic powder in the core having a high Young's module is more than that of the soft magnetic powder in the core having a low Young's module. The content of the soft magnetic powder in the core having a high Young's module is, for example, 60% by volume or more and 85% by volume or less, further 70% by volume or more and 80% by volume or less. The content of the soft magnetic powder in the core having a low Young's module is, for example, 20% by volume or more and 78% by volume or less, further 30% by volume or more and 75% by volume or less.

In a second method, the Young's module of the compact of the composite material is adjusted by changing the type of the soft magnetic powder. The higher the Young's module of the soft magnetic powder, the higher the Young's module of the compact of the composite material. The Young's module of the compact of the composite material increases by selecting the soft magnetic powder having a high Young's module.

The Young's module of the soft magnetic powder in the core having a high Young's module is set higher than that of the soft magnetic powder in the core having a low Young's module. The type of the soft magnetic powder in the core having a high Young's module is, for example, a powder of an iron-based alloy. Specific examples of the iron-based alloy having a high Young's module include amorphous Fe alloys and Fe—Si—Al alloys. The type of the soft magnetic powder in the core having a low Young's module is, for example, a powder of pure iron.

In a third method, the Young's module of the compact of the composite material is adjusted by changing the type of the resin or the grade of the resin. The higher the Young's module of the resin, the higher the Young's module of the compact of the composite material. The Young's module of the compact of the composite material increases by selecting the resin having a high Young's module.

The Young's module of the resin in the core having a high Young's module is set higher than that of the resin in the core having a low Young's module. The type of the resin in the core having a high Young's module and the type of the resin in the core having a low Young's module may be the same or different. If the types of the resins are the same, a resin of a grade having a high Young's module is selected as the resin in the core having a high Young's module, and a resin of a grade having a low Young's module is selected as the resin in the core having a low Young's module.

In a fourth method, the Young's module of the compact of the composite material is adjusted by applying a surface processing to the soft magnetic powder. The higher the adhesion between the soft magnetic powder and the resin, the higher the Young's module of the compact of the composite material. Thus, the Young's module of the compact of the composite material increases by enhancing the adhesion between the soft magnetic powder and the resin by the surface processing. The surface processing is, for example, silane coupling. The surface processing is applied to the soft magnetic powder in the core having a high Young's module.

In this embodiment, the Young's module of the first core 3a is larger than that of the second core 3b. That is, the Young's module of the first middle core portion 31a is larger than that of the second middle core portion 31b. When the recess 7 and the protrusion 8 are fit as shown in FIG. 3, a part in contact with the inclined surface 73 of the recess 7 is deformed in the protrusion 8 of the second middle core portion 31b having a low Young's module. Further, if the recess 7 and the protrusion 8 are in surface contact, the inclined surface 83 of the protrusion 8 in surface contact with the inclined surface 73 is compressed. As a result, the protrusion 8 is press-fit into the recess 7.

If the Young's module of the first core 3a is smaller than that of the second core 3b, the contact portion 75 in contact with the protrusion 8 is deformed in the recess 7 of the first middle core portion 31a having a low Young's module. The contact portion 75 in surface contact with the inclined surface 83 of the protrusion 8 is pressed, and the protrusion 8 is press-fit into the recess 7. In this case, the inner peripheral surface 72 of the recess 7 is deformed to expand. Thus, the wall constituting the recess 7 is easily deformed. The Young's module of the first core 3a larger than that of the second core 3b as in this embodiment is advantageous in that excessive deformation of the wall of the recess 7 can be suppressed.

### Functions and Effects of Third Embodiment

A volume of a gap portion 3g is easily adjusted by first and second gap portions 31g, 32g in the reactor of the third embodiment, similarly to the reactor 1a of the first embodiment.

Further, according to the reactor of the third embodiment, the part of the protrusion 8 in contact with the recess 7 is deformed with the recess 7 and the protrusion 8 fit. In this way, position shifts of the protrusion 8 in the Y and Z directions with respect to the recess 7 are less likely to occur. Thus, the fitting state of the recess 7 and the protrusion 8 is more easily maintained. Further, since the protrusion 8 is press-fit into the recess 7, the positioning accuracy of the protrusion 8 with respect to the recess 7 is further improved. Moreover, since the fitting strength of the recess 7 and the protrusion 8 is improved by a press-fit effect, the joint strength of the first and second middle core portions 31a, 31b is improved. Even if a stress due to vibration or heat is applied during the use of the reactor, the protrusion 8 is less likely to come out from the recess 7. The first and second middle core portions 31a, 31b are firmly coupled.

### Fourth Embodiment

A reactor of a fourth embodiment differs from the reactor of the second embodiment in that a Young's module of a first core 3a and that of a second core 3b are different. That is, a Young's module of a first middle core portion 31a and that of a second middle core portion 31b are different. Since the other configuration is the same as the reactor of the second embodiment shown in FIG. 6 except different Young's moduli, it is not shown.

A magnitude relationship of the Young's module of the first core 3a and that of the second core 3b is not particularly limited. A difference between the Young's module of the first core 3a and that of the second core 3b, i.e. a difference between the Young's module of the first middle core portion 31a and that of the second middle core portion 31b, is, for example, 5 GPa or more and 30 GPa or less, further 5 GPa or more and 20 GPa or less. In this embodiment, the Young's modulus of the first core 3a is smaller than that of the second core 3b. That is, the Young's modulus of the first middle core portion 31a is smaller than that of the second middle core portion 31b. When a recess 7 and a protrusion 8 are fit as shown in FIG. 6, an inclined surface 73 in line contact with a peripheral edge part 84 of a top surface 81 is locally depressed in the recess 7 of the first middle core portion 31a having a low Young's modulus.

If the Young's modulus of the first core 3a is larger than that of the second core 3b, the peripheral edge part 84 in line contact with the inclined surface 73 of the recess 7 is locally squeezed on the protrusion 8 of the second middle core portion 31b having a low Young's modulus.

### Functions and Effects of Fourth Embodiment

A volume of a gap portion 3g is easily adjusted by first and second gap portions 31g, 32g in the reactor of the fourth embodiment, similarly to the reactor 1a of the first embodiment. Since the volume of the gap portion 3g is increased in the reactor of the fourth reactor, similarly to the reactor of the second embodiment, an improvement in inductance characteristics can be expected.

Further, according to the reactor of the fourth embodiment, the part of the protrusion 8 in contact with the recess 7 is locally deformed with the recess 7 and the protrusion 8 fit. In this way, position shifts of the protrusion 8 in the Y and Z directions with respect to the recess 7 are less likely to occur. Thus, the fitting state of the recess 7 and the protrusion 8 is more easily maintained.

### First Modification

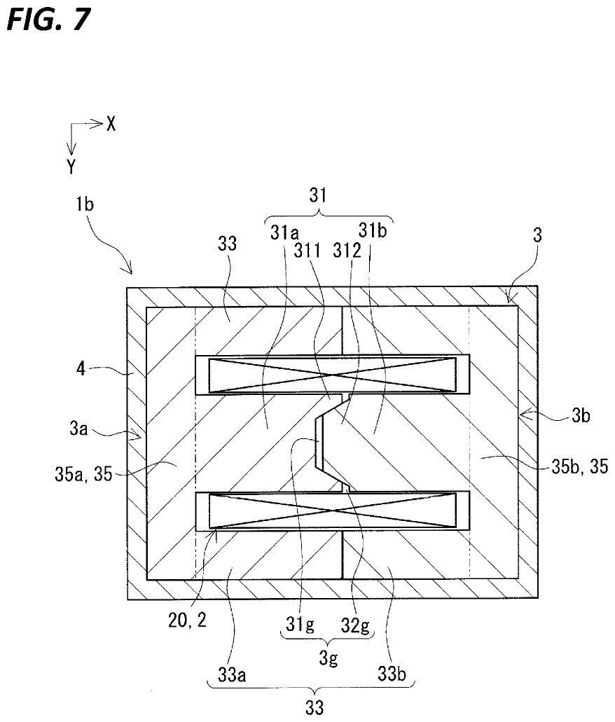

A reactor 1b of a first modification is described with reference to FIG. 7. The reactor 1b of the first modification differs from the reactor 1a of the first embodiment in that a magnetic core 3 is of an E-E type. The following description is centered on points of difference from the first embodiment. Components similar to those of the first embodiment are denoted by the same reference signs and not described.

### <Magnetic Core>

The magnetic core 3 is configured by combining a first core 3a and a second core 3b in the X direction as in the first embodiment. The magnetic core 3 has a θ shape when viewed from the Z direction as shown in FIG. 7.

In the first modification, each of two side core portions 33 is divided in the X direction. The side core portion 33 includes a first side core portion 33a and a second side core portion 33b. The first side core portion 33a is located on one side in the X-direction. An end part of the first side core portion 33a is connected to a first end core portion 35a. The second side core portion 33b is located on the other side in the X-direction. An end part of the second side core portion 33b is connected to a second end core portion 35b.

An end surface of the first side core portion 33a and that of the second side core portion 33b are in contact with each other. A length of each of the first and second side core portions 33a, 33b may be set as appropriate. The length mentioned here means a length along the X direction.

The first core 3a includes a first middle core portion 31a, the first end core portion 35a and two first side core portions 33a. The first middle core portion 31a, the first end core portion 35a and the two first side core portions 33a are integrally formed. The respective first side core portions 33a extend in the X direction from both end parts in the Y direction of the first end core portion 35a toward the second side core portions 33b. The first core 3a is E-shaped when viewed from the Z direction.

The second core 3b includes a second middle core portion 31b, the second end core portion 35b and two second side core portions 33b. The second middle core portion 31b, the second end core portion 35b and the two second side core portions 33b are integrally formed. The respective second side core portions 33b extend in the X direction from both end parts in the Y direction of the second end core portion 35b toward the first side core portions 33a. The second core 3b is E-shaped when viewed from the Z direction.

In FIG. 7, the configuration of a first end part 311 of the first middle core portion 31a and that of a second end part 312 of the second middle core portion 31b are similar to those of the first embodiment shown in FIGS. 3 to 5. That is, as shown in FIG. 3, the first end part 311 of the first middle core portion 31a includes a recess 7 and a first surface 70. The second end part 312 of the second middle core portion 31b includes a protrusion 8 and a second surface 80.

In the reactor 1b of the first modification, the configuration of each of the second to fourth embodiments is applicable.

### Second Modification

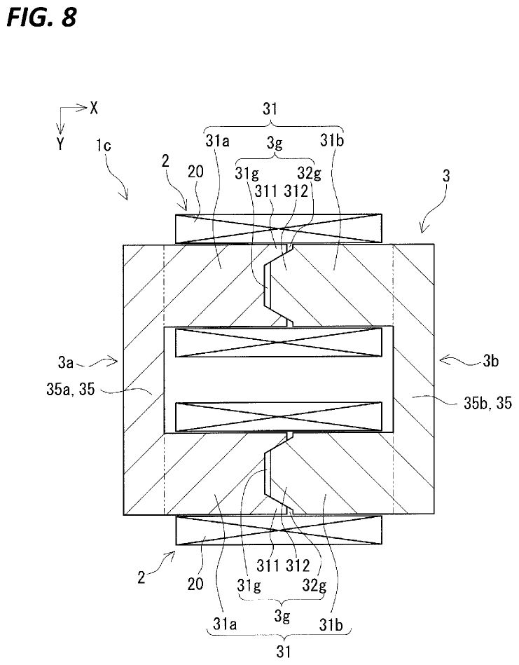

A reactor 1c of a second modification is described with reference to FIG. 8. The reactor 1c of the second modification differs from the reactor 1a of the first embodiment in that a coil 2 includes two winding portions 20 and a magnetic core 3 is of a U-U type. The following description is centered on points of difference from the first embodiment. Components similar to those of the first embodiment are denoted by the same reference signs and not described. The resin molded member 4 described in the first embodiment is not provided in the second modification.

### <Coil>

The coil 2 includes two winding portions 20. The two winding portions 20 are arranged in parallel so that axial directions thereof are parallel. Each winding portion 20 has a rectangular tube shape. Each winding portion 20 has the same turn number. The two winding portions 20 are electrically connected in series. The two winding portions 20 may be formed by spirally winding separate winding wires or formed by one continuous winding wire.

### <Magnetic Core>

The magnetic core 3 is configured by combining a first core 3a and a second core 3b in the X direction as in the first embodiment. The magnetic core 3 has an O shape when viewed from the Z direction as shown in FIG. 8. In the second modification, the magnetic core 3 includes two middle core portions 31 and two end core portions 35. A parallel direction of the two middle core portions 31 is the Y direction.

Each of the two middle core portions 31 extends in the X direction. The two middle core portions 31 are arranged in parallel such that axial directions thereof are parallel. The respective middle core portions 31 include parts to be arranged inside the two winding portions 20. Each middle core portion 31 has a substantially rectangular parallelepiped shape. Each middle core portion 31 is divided in the X direction and includes a first middle core portion 31a and a second middle core portion 31b. Each first middle core portion 31a is located on one side in the X direction. Each second middle core portion 31b is located on the other side in the X direction.

Further, each middle core portion 31 includes a gap portion 3g. The gap portion 3g is provided between the first and second middle core portions 31a, 31b. The gap portion 3g is located inside the winding portion 20. The gap portion 3g includes a first gap portion 31g and a second gap portion 32g.

The end core portions 35 include a first end core portion 35a and a second end core portion 35b. The first end core portion 35a is located on the one side in the X direction and facing one end surface of each winding portion 20. An end part of each first middle core portion 31a is connected to the first end core portion 35a. That is, the first end core portion 35a links the end parts of the first middle core portions 31a. The second end core portion 35b is located on the other side in the X direction and facing the other end surface of each winding portion 20. An end part of each second middle core portion 31b is connected to the second end core portion 35b. That is, the second end core portion 35b links the end parts of the second middle core portions 31b. Each of the first and second end core portions 35a, 35b has a substantially rectangular parallelepiped shape.

The first core 3a includes the first middle core portion 31a of each of the two middle core portions 31 and the first end core portion 35a. The two first middle core portions 31a and the first end core portion 35a are integrally formed. The respective first middle core portions 31a extend in the X direction from both end parts in the Y direction of the first end core portion 35a toward the respective second middle core portions 31b. The first core 3a is U-shaped when viewed from the Z direction.

The second core 3b includes the second middle core portion 31b of each of the two middle core portions 31 and the second end core portion 35b. The two second middle core portions 31b and the second end core portion 35b are integrally formed. The respective second middle core portions 31b extend in the X direction from both end parts in the Y direction of the second end core portion 35b toward the respective first middle core portions 31a. The second core 3b is U-shaped when viewed from the Z direction.

In FIG. 8, the configuration of a first end part 311 of the first middle core portion 31a and that of a second end part 312 of the second middle core portion 31b are similar to those of the first embodiment shown in FIGS. 3 to 5. That is, as shown in FIG. 3, the first end part 311 of the first middle core portion 31a includes a recess 7 and a first surface 70. The second end part 312 of the second middle core portion 31b includes a protrusion 8 and a second surface 80. In this example, the two middle core portions 31 have the same configuration. Unlike this example, in one middle core portion 31, the first end part 311 of the first middle core portion 31a may include the protrusion 8 and the second surface 80 and the second end part 312 of the second middle core portion 31b may include the recess 7 and the first surface 70. In this example, each of the two middle core portions 31 includes the recess 7 and the protrusion 8. Unlike this example, only one middle core portion 31 may include the recess 7 and the protrusion 8 and the other middle core portion 31 may be configured such that flat surfaces contact each other.

In the reactor 1c of the second modification, the configuration of each of the second to fourth embodiments is applicable.

### Fifth Embodiment

### [Converter, Power Conversion Device]

The reactors of the first to fourth modifications and the first and second modifications can be utilized for applications satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactors of the first to fourth modifications and the first and second modifications can be typically used as a constituent component of a converter to be installed in a vehicle such as an electric vehicle or a hybrid vehicle or as a constituent component of a power conversion device provided with this converter.

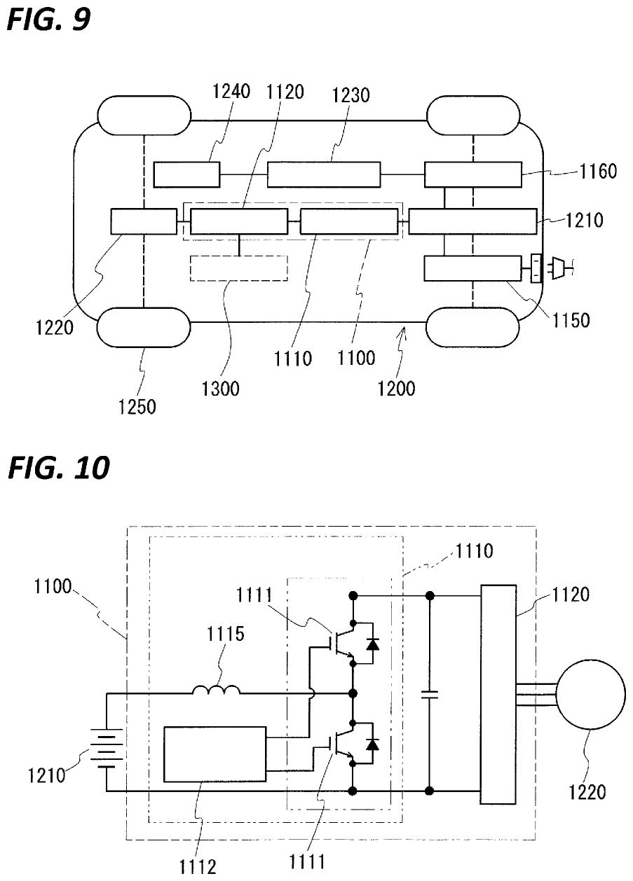

A vehicle 1200 such as a hybrid vehicle or an electric vehicle is, as shown in FIG. 9, provided with a main battery 1210, a power conversion device 1100 connected to the main body 1210 and a motor 1220 used for travel by being driven by power supplied from the main body 1210. The motor 1220 is, typically, a three-phase alternating current motor. The motor 1220 drives wheels 1250 during travel and functions as a generator during regeneration. In the case of a hybrid vehicle, the vehicle 1200 includes an engine 1300 in addition to the motor 1220. FIG. 9 shows an inlet as a charging point of the vehicle 1200, but the vehicle 1200 can include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the main battery 1210 with the direct-current voltage during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current output from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 10 and converts an input voltage by being repeatedly turned on and off. The conversion of the input voltage means voltage step-up and-down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. The reactor of any one of the first to fourth modifications and the first and second modifications is provided as the reactor 1115. By including the reactor of any one of the first to fourth modifications and the first and second modifications, the reactor has stable inductance characteristics.

Besides the converter 1110, the vehicle 1200 is provided with a power supply device converter 1150 connected to the main battery 1210 and an auxiliary power supply converter 1160 connected to a sub-battery 1230 and the main battery 1210 serving as power sources of auxiliary devices 1240 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to the reactor of any one of the first to fourth modifications and the first and second modifications and appropriately changed in size, shape and the like can be used as reactors of the power supply device converter 1150 and the auxiliary power supply converter 1160. Further, the reactor of any one of the first to fourth modifications and the first and second modifications can also be used as a converter for converting input power and only stepping up a voltage or only stepping down a voltage.

### LIST OF REFERENCE NUMERALS

1a, 1b, 1c reactor
2 coil
20 winding portion
21 end portion, 21a first end portion, 21b second end portion
3 magnetic core
3a first core, 3b second core
31 middle core portion
31a first middle core portion, 31b second middle core portion
311 first end part, 312 second end part
33 side core portion
33 first side core, 33b second side core portion
35 end core portion
35a first end core portion, 35b second end core portion
3g gap portion
31g first gap portion, 32g second gap portion
4 resin molded member
7 recess, 70 first surface
71 bottom surface, 72 inner peripheral surface, 73 inclined surface
75 contact portion
8 protrusion, 80 second surface
81 top surface, 82 outer peripheral surface, 83 inclined surface
84 peripheral edge part
g1, g2 length
a, w1, w2 width
d depth, t thickness, p height
s contact length, f fitting length
Cx axis
α, β angle of inclination
1100 power conversion device
1110 converter, 1111 switching element, 1112 drive circuit
1115 reactor, 1120 inverter
1150 power supply device converter, 1160 auxiliary power supply converter
1200 vehicle
1210 main battery, 1220 motor, 1230 sub-battery
1240 auxiliary devices, 1250 wheel
1300 engine

1. A reactor, comprising:
a coil including a winding portion; and
a magnetic core including a middle core portion,
the winding portion being arranged on the middle core portion,
the middle core portion including:
a first middle core portion and a second middle core portion divided in an axial direction of the winding portion; and
a gap portion provided between the first and second middle core portions,
the first middle core portion including a first end part facing the second middle core portion,
the second middle core portion including a second end part facing the first middle core portion,
the first end part including a recess open toward the second middle core portion and an annular first surface, the recess being open in the first surface,
the second end part including a protrusion fit in the recess and an annular second surface facing the first surface while being spaced apart from the first surface in the axial direction,
the recess being formed to become smaller with distance from the first surface,
a bottom surface of the recess facing a top surface of the protrusion while being spaced apart from the top surface in the axial direction,
an inner peripheral surface of the recess including an inclined surface intersecting an axis along the axial direction,
the inclined surface of the recess including a contact portion in contact with the protrusion, and
the gap portion including:
a first gap portion formed between the bottom surface and the top surface; and
an annular second gap portion formed between the first surface and the second surface.

2. The reactor of claim 1, wherein each of the first and second middle core portions is constituted by a compact of a composite material in which a soft magnetic powder is dispersed in a resin.

3. The reactor of claim 1, wherein a maximum length of the first gap portion is 0.3 mm or more and 3 mm or less.

4. The reactor of claim 1, wherein a maximum length of the second gap portion is 0.3 mm or more and 3 mm or less.

5. The reactor of claim 1, wherein an angle of inclination a of the inclined surface of the recess is 30° or more and 60° or less.

6. The reactor of claim 1, wherein:
the protrusion is formed to become smaller with distance from the second surface,
an outer peripheral surface of the protrusion includes an inclined surface inclined along the inclined surface of the recess, and
the inclined surface of the recess and the inclined surface of the protrusion are in surface contact at the contact portion.

7. The reactor of claim 6, wherein a length of the contact portion is 0.5 mm or more and 5 mm or less.

8. The reactor of claim 1, wherein:
an angle of inclination β of an outer peripheral surface of the protrusion is smaller than an angle of inclination α of the inclined surface of the recess, and
the inclined surface of the recess and a peripheral edge part of the top surface of the protrusion are in line contact at the contact portion.

9. The reactor of claim 1, wherein each of a Young's modulus of the first middle core portion and that of the second middle core portion is 20 GPa or more and 50 GPa or less.

10. The reactor of claim 9, wherein the Young's modulus of the first middle core portion and that of the second middle core portion are equal.

11. The reactor of claim 9, wherein the Young's modulus of the first middle core portion and that of the second middle core portion are different.

12. The reactor of claim 11, wherein a difference between the Young's modulus of the first middle core portion and that of the second middle core portion is 5 GPa or more and 30 GPa or less.

13. The reactor of claim 1, wherein:
the magnetic core is composed of a first core and a second core,
the first core includes the first middle core portion, and
the second core includes the second middle core portion.

14. A converter, comprising the reactor of claim 1.

15. A power conversion device, comprising the converter of claim 14.
